(19) United States
(12) Patent Application Publication
(10) Pub. No.: US 2016/0103525 A1
(43) Pub. Date: Apr. 14, 2016

(54) SENSE SIGNALS FOR TOUCH PANELS

(71) Applicant: KAPIK INC., Toronto (CA)

(72) Inventor: William Martin SNELGROVE, Toronto (CA)

(21) Appl. No.: 14/878,254

(22) Filed: Oct. 8, 2015

Related U.S. Application Data
(60) Provisional application No. 62/061,544, filed on Oct. 8, 2014.

(51) Int. Cl. G06F 3/044

(52) U.S. Cl. CPC G06F 3/044

(57) ABSTRACT

In capacitive touch panels arrays, self- and mutual capacitances of embedded sense lines in rows and columns are measured to estimate the position of probes such as fingers, styli and the like. Signals are driven onto the sense lines in order to estimate capacitances, but it is desired to keep these signals as weak as possible in order to minimize power consumption, voltage drive requirements and electromagnetic interference. Accurate detection of the position of the probe, particularly with weak signals, is rendered difficult by its motion. Techniques are proposed for power-efficient drive signals and related techniques proposed that are operable to estimate velocity. Dual receive structures with similar properties are proposed.

### CROSS-REFERENCE TO RELATED APPLICATION

This application claims the benefit of U.S. Provisional Patent Application 62/061,544, Filed Oct. 8, 2014, the entire contents of which are incorporated herein by reference.

### FIELD

The present invention relates to a system and method for sensing capacitances in touch panels.

### BACKGROUND

Capacitive touch panels, such as those used in smart phones and tablets, embed a grid of transparent wires in their screens. These sense lines are connected through cabling to circuits that measure the capacitances of and between these lines to detect the presence and position of fingers, styli, brushes and the like.

### SUMMARY

It is desirable to sense touch-panel capacitances and similar quantities such that position and velocity are simultaneously measured; it is further desirable to choose drive waveforms and measurement sequences for power efficiency.

The present invention relates to a system and method for sensing capacitances in touch panels, wherein sense waveforms are chosen to permit simultaneous estimation of position and velocity. Modulation of sense waveforms by motion of a probe is detected in order to estimate velocity.

The technique can be combined with use of predictive filters, such as modified Kalman filters, for tracking rapidly moving probes. Inductive loading can be used to improve power efficiency and reduce interference.

Variations of the technique can be applied for one-dimensional sensing, for separable two-dimensional sensing and for mutual-capacitance sensing.

Whole-screen acquisition can be be combined using superposition with higher-power sensing focussed on probe areas. Sensing power can be increased in difficult areas, such as corners, to mitigate signal losses.

In accordance with an aspect of the invention, there is provided a sensing system for measuring a position and a velocity of a probe. The sensing system includes a panel. The sensing system also includes a plurality of sense lines disposed in the panel. The plurality of sense lines are configured to measure data associated with the probe. In addition, the sensing system includes a driver circuit connected to the plurality of sense lines. The driver circuit is configured transmit a plurality of drive signals at an initial frequency to the plurality of sense lines. Furthermore, the sensing system includes a receiver circuit connected to the plurality of sense lines. The receiver circuit is configured to receive a plurality of sensed signals, each sensed signal of the plurality of sensed signals being received from a sense line of the plurality of sense lines, wherein each sensed signal comprises a sensed phased and a sensed frequency. Also, the sensing system includes a plurality of differencing circuits configured to phase-shift a signal associated with each sense line of the plurality of sense lines. The sensing system further includes a signal processing circuit connected to receive a plurality of processing signals associated with the plurality of sensed signals. The signal processing circuit is configured to determine correlation components of each processing signal with an associated drive signal to calculate a position and a velocity of the probe.

Each drive signal of the plurality of drive signals may be a sinusoid. The correlation components may include a measured phase and a measured frequency.

The signal processing circuit may be configured to correlate the plurality of processing signals with complex exponentials at different frequencies.

The plurality of differencing circuits may be configured to phase-shift each drive signal of the plurality of drive signals by a different amount.

The plurality of differencing circuits may be configured to phase-shift a first drive signal about 90 degrees relative to a second drive signal, wherein the first drive signal and the second drive signal are associated with adjacent sense lines.

The plurality of differencing circuits may be configured to phase-shift each sensed signal of the plurality of sensed signals by a different amount.

The plurality of differencing circuits may be configured to phase-shift a first sensed signal about 90 degrees relative to a second sensed signal to generate a first processing signal and a second processing signal, respectively, wherein the first sensed signal and the second sensed signal are associated with adjacent sense lines.

The plurality of sense lines may include a conductive material.

The receiver circuit may be configured to detect a capacitance from the plurality of sense lines.

Each drive signal may include a Walsh waveform.

In accordance with another aspect of the invention, there is provided a method of measuring a position and a velocity of a probe. The method involves transmitting, using a driver circuit, a plurality of drive signals to a plurality of sense lines. Furthermore, the method involves receiving, using a receiver circuit, a plurality of sensed signals, each sensed signal of the plurality of sensed signals being received from a sense line of the plurality of sense lines, wherein each sensed signal comprises a sensed phased and a sensed frequency. In addition, the method involves phase-shifting, using a plurality of differencing circuits, a signal associated with each sense line of the plurality of sense lines. Also, the method involves determining, using a signal processing circuit, correlation components of each processing signal of a plurality of processing signals associated with the plurality of sensed signals. The method further involves calculating a position and a velocity of the probe using the correlation components of each processing signal of a plurality of processing signals.

Transmitting may involve transmitting a plurality of sinusoidal drive signals. The correlation components may include a measured phase and a measured frequency.

The method may further involve correlating, using the signal processing circuit, the plurality of processing signals with complex exponentials at different frequencies.

Phase-shifting a signal may involve phase-shifting each drive signal of the plurality of drive signals by a different amount.

Phase-shifting may involve phase-shifting a first drive signal about 90 degrees relative to a second drive signal, wherein the first drive signal and the second drive signal are associated with adjacent sense lines.

The plurality of sense lines may include a conductive material.

Receiving a plurality of sensed signals may involve receiving capacitance data from the plurality of sense lines.

Transmitting may involve transmitting a plurality of Walsh waveforms.

### BRIEF DESCRIPTION OF THE DRAWINGS

Reference will now be made, by way of example only, to the accompanying drawings in which:

FIG. 1 shows a cross-section illustrating column sensing in a self-capacitance touch screen, with two fingers whose positions are to be sensed;

FIG. 2 shows self-capacitance profiles for sensing in the screen of FIG. 1, illustrating single-ended self-capacitance sensing;

FIG. 3 shows a plan view illustrating row and column sensing in a touch screen, with two fingers whose positions are to be sensed;

FIG. 4 shows orthogonal waveforms being used to drive rows so that columns may be simultaneously sensed;

FIG. 5 shows co-pending differential drive combined with Walsh waveforms being used to drive rows while reducing electromagnetic interference and emphasizing edge detail;

FIGS. 6A-D shows measured capacitance profiles when sensing a single finger, using various combinations of single-ended and differential drive and sensing;

FIG. 7A-B shows measured differential mutual capacitance with a Walsh row drive waveform when a probe moves horizontally;

FIGS. 8A-B shows measured cross-sections of capacitance profiles for single-ended cases;

FIG. 9A-B shows measured cross-sections of capacitance profiles for differential cases;

FIG. 10 shows complex column sensing in a self-capacitance touch screen, with two fingers whose positions and velocities are to be sensed; and

FIG. 11 shows a one-dimensional Fourier transform per column of received single-ended column voltages in a touch panel having sparse 4-phase single-frequency drive and interference from a switching regulator.

### DETAILED DESCRIPTION OF THE EMBODIMENTS

The present invention relates to a system and method for sensing capacitances in touch panels, wherein sense waveforms are chosen to permit simultaneous estimation of position and velocity. Modulation of sense waveforms by motion of a probe is detected in order to estimate velocity. The technique can be combined with use of predictive filters, such as modified Kalman filters, for tracking rapidly moving probes.

Therefore, power consumption can concentrated on driving sense lines and on making accurate measurements in areas where probes are located instead of uniformly spread over the panel and uniformly consumed regardless of the number or even presence of probes. It is to be appreciated by a person of skill in the art with the benefit of this description that by concentrating power in a specific area, accuracy of measurements can be increased without significantly increasing power consumption of the touch panel.

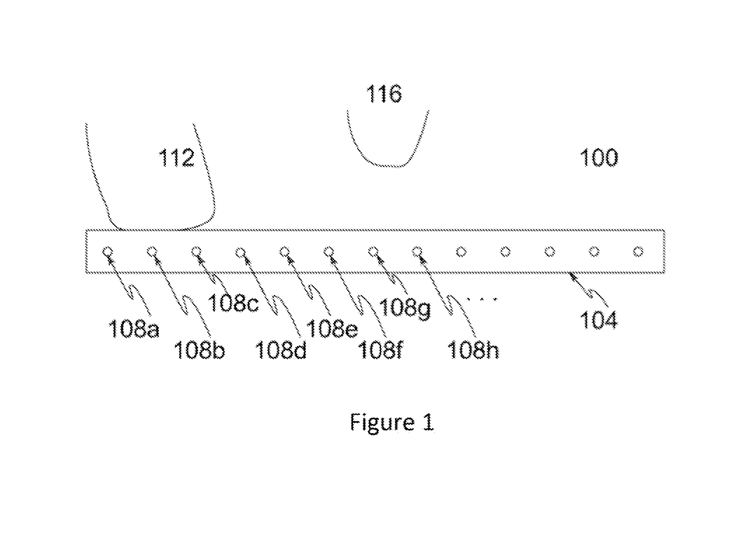

In a touch panel, there are two layers of sense lines—one with wires disposed in rows and one with wires disposed in columns. These sense lines are typically spaced at a pitch of approximately 6 mm, both in the row and column directions. FIG. 1 shows generally at 100 a cross-section of a touch panel 104 containing column sense lines 108a, 108b etc. with two fingers 112 and 116 in proximity. A cross-section showing rows would be similar, but with the row sense lines vertically separated from the columns.

Fingers 112 and 116 increase the self-capacitance of sense lines 108, not just directly beneath the fingers but generally nearby according to the laws of electrostatics. They also reduce the mutual capacitance between lines, in particular between row and column sense lines, through a kind of shielding effect.

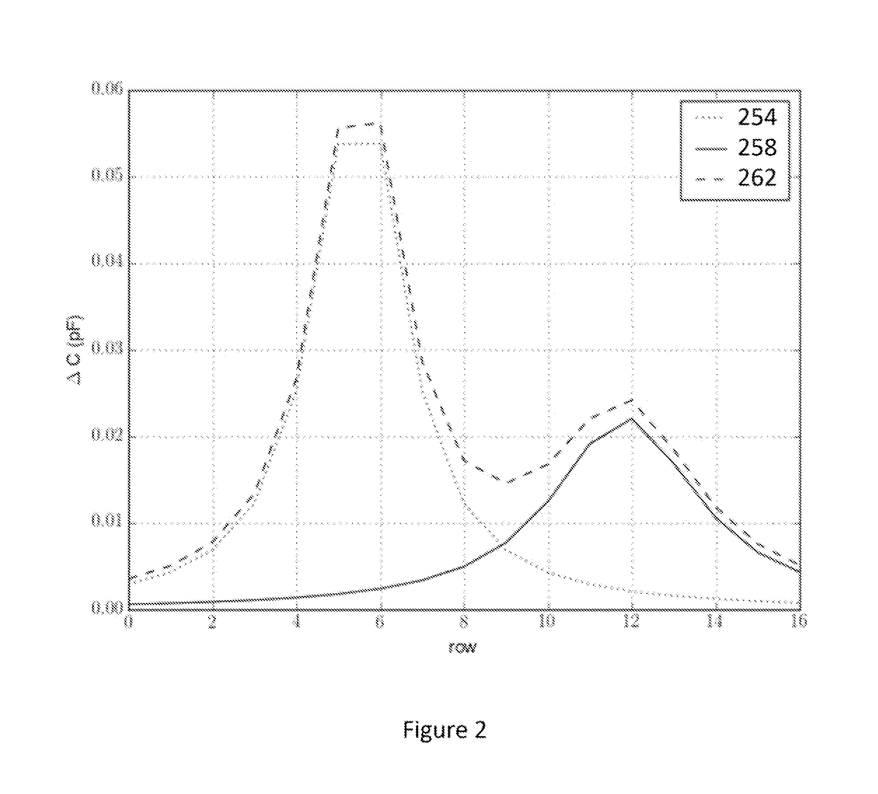

FIG. 2 shows generally capacitances for 17 rows of an exemplary touch panel with two fingers nearby. The values labelled on the y-axis of the graph are differences from baseline capacitance due to the presence of the fingers: baseline capacitance would be on the order of 100 pF for an exemplary panel, and would vary with position due to edge effects and mounting hardware: thus it is necessary to detect small changes in a large variable. Trace 254 shows the effect of finger 112 alone, with elevated capacitance at rows 5 and 6 but also with substantial fringing capacitance for several rows in each direction. Trace 258, similarly, shows the effect of finger 116 alone, and trace 262 shows the combined effect of both fingers. These are the measurements from which the positions of the fingers are estimated.

Note that traces 258 and 262 show a consistent signature shape: in mathematical terms they are approximately samples of a function of the form k/(1+cx̂2), where x is the position of the finger along the panel, and where c and k are indicative of size and height. Estimation of finger position typically proceeds using knowledge of this signature: for example by correlating measured data with an expected signature.

FIG. 2 showed self-capacitance, and for a panel touched at a single point it is enough to locate the touch in the x direction (by sensing columns) and the y direction (by sensing rows). For a multi-touch system there is ambiguity in pairing x coordinates with y coordinates, so mutual-capacitance sensing is used. Hybrid sensing, in which mutual capacitance measurements are used just for disambiguation and the accurate position sensing is done using the simpler self-capacitance methods.

The typical 6 mm spacing of sense lines 108 is fine enough to detect the presence of a finger, which might typically be represented as a grounded conductor of approximately 8 mm diameter, but it is generally desired to resolve the position of the finger to within 1 mm. This super-resolution can be obtained, but requires making measurements with signal-to-noise ratios of typically 20 dB or better. High signal-to-noise ratios in turn require large drive voltages or long sensing times. High drive voltages are not compatible with advanced integrated-circuit technologies, and long sensing times are not compatible with the fast response desired for a good user experience.

Compounding the signal to noise ratio problems due to short sensing time and low voltages, users wish to be able to use a stylus or brush on these panels, and these devices can be much smaller than a finger: a 1 mm stylus tip is not unusual. The small size of the target to be sensed reduces its effect on sense-line capacitances, especially when it is midway between sense lines.

Long sensing times permit improvement of signal to noise ratio by an averaging process, but the length of time available for averaging is limited by the required scan rate to provide low latency for the user and to track rapid motion of the probe. Scan rates for typical tablets are currently in excess of 250 Hz, limiting averaging to a few milliseconds.

All of these problems become worse with large panels. Higher-frequency operation can allow more averaging, but large panels have long sense lines with substantial RC losses, limiting bandwidth. The speed of probe motion increases with panel size according to Fitts' Law: for telephones and small tablets speeds are on the order of 200 mm/sec, while for large panels speeds in normal operation can reach 2 m/s. At 2 m/s and 250 Hz sensing, a probe moves 8 mm per sensing frame, i.e. more than a grid spacing and an order of magnitude more than the required resolution.

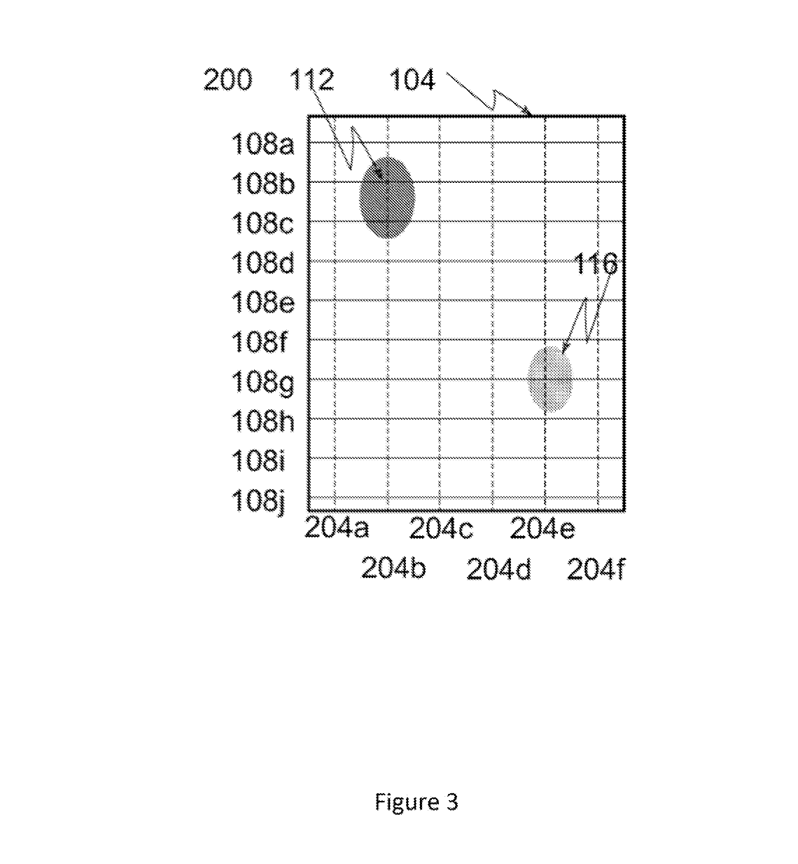

Referring to FIG. 3, a touch screen with row and column sensing is generally shown at 200. The touch screen 200 includes row sense lines 108a, 108b etc. and column sense lines 204a, 204b, etc.

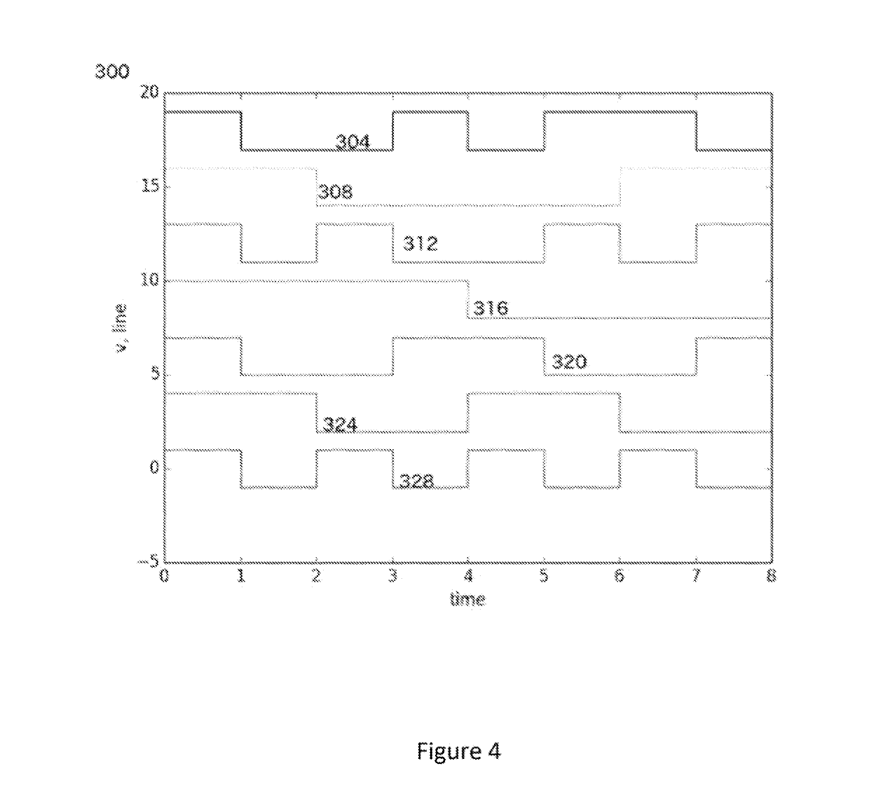

For small panels it has been conventional to sense mutual capacitances by driving sequences of pulses into rows, one at a time, and measuring induced currents on columns. Use of denser orthogonal sets of drive signals, e.g. Walsh functions or sinusoids at different frequencies, makes it possible to sense multiple rows at a time and thereby improve signal-to-noise ratio while maintaining high scan rates for large panels. These techniques are necessary for mutual capacitance measurement but not for self-capacitance. FIG. 4 shows generally at 300 a set of 7 Walsh-Hadamard drive sequences (offset for readability) 304, 308 etc. up to 328. These are orthogonal functions used to stimulate row lines such that their combinations can be read and distinguished on column lines. Their orthogonality means that correlating a received signal with the same sequences produces estimates of the contributions of each sequence.

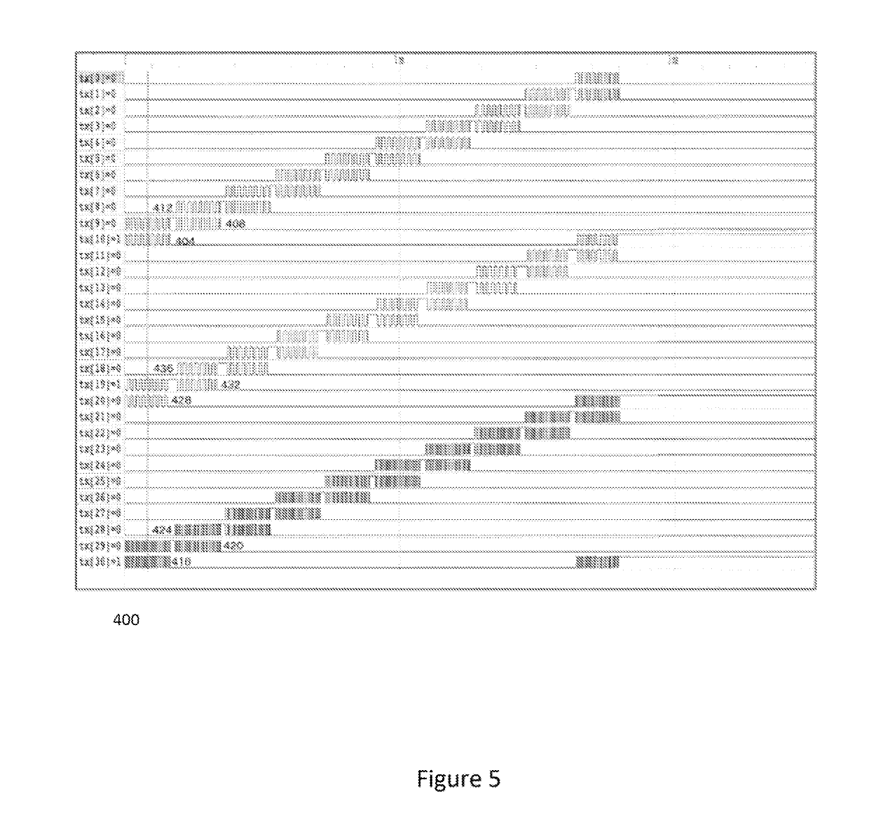

FIG. 5 shows generally at 400 use of differential versions of Walsh-Hadamard functions in groups. Advantageously, the use of differential signals corrects the electromagnetic interference due to any orthogonal set on its own, and use on receive reduces sensitivity to interference. FIG. 5 shows one particular implementation of differential transmission. Signals 404 and 408 form a differential pair on sense lines tx[9] and tx[10] for two Walsh periods of 8 cycles each, with sequence (1, 1, −1, −1, 1, 1, −1, −1); then 408 and 412 form a differential pair on sense lines tx[9] and tx[8] for another two Walsh periods, and so on. Simultaneously with 404 and 408 driving lines tx[9] and tx[10] differentially, signals 416 and 420 drive lines tx[29] and tx[30] with code [1, −1, 1, −1, 1, −1, 1, −1] and signals 428 and 432 drive tx[19] and tx[20] differentially with code [−1, 1, 1, −1, −1, 1, 1, −1]. Similarly, pairs (420. 424) and (428, 432) operate simultaneously with the pair (408, 412): thus at any time three pairs of lines are being probed.

The use of Walsh-Hadamard sequences is convenient for driving lines and for correlation on receive, because of their simple mathematical form, but distortion by RC delays in sense lines causes unwanted correlation components. It is to be appreciated with the benefit of this specification that first-order correction of this problem can be carried out by manipulating timing. Another difficulty is that periodic interference, e.g. from switching power supplies, can correlate with the drive sequences: changing clocking frequencies to mitigate this problem, but it is necessary to detect and track this interference.

Driving sense lines consumes power, typically according to the well-known formula CV²f: most of it wasted. Power spent when there is no probe present, which is most of the time, is wasted except inasmuch as it is necessary to detect a change; power spent on areas of the screen with no probe nearby, which is most of the screen, similarly yields a very low information rate; and the formula itself is symptomatic of lack of impedance matching or a simplistic drive scheme. It is to be appreciated with the benefit of this description that use of an improved drive scheme using shorting switches can reduce driver power.

Driving sense lines with orthogonal sequences, such as shown in FIG. 4, produces electromagnetic interference. By driving sense lines differentially, as shown generally at 400 in FIG. 5, electromagnetic interference can be largely cancelled, dropping off as the fourth power of distance from the panel.

The problems of signal drive have duals in signal reception. Large self-capacitances increase power requirements for amplifiers at a given noise level; analog-to-digital converters and amplifiers cost power and are mostly sensing nothing; averaging is desirable but motion makes it difficult; and the use of differential reception reduces sensitivity to external interference.

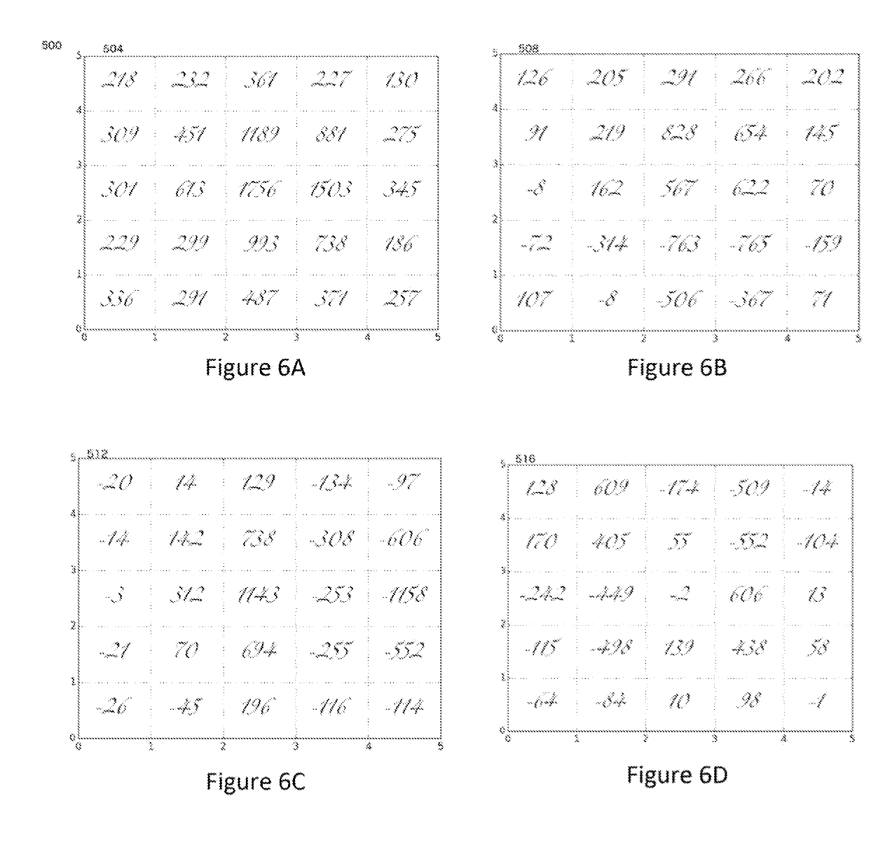

FIGS. 6A-D shows generally at 500 mutual capacitance measurements (with a unit of measurement corresponding to approximately 100 aF) at intersections of rows and columns for various choices of single-ended and differential drive and receive. At 504 single-ended drive and receive produces a profile with approximately circular symmetry and a diameter, where the peak indicates the location of a probe. At 508 differential row drive produces a profile with a lobe in the row direction, where the zero crossing indicates the location of the probe in the row direction, but the peak indicates its location in the column direction. At 512 is shown the dual of 508, with single-ended drive and differential receive. At 516 is shown the two-dimensional measurement profile resulting from differential drive and receive, wherein the location of the probe center is indicated by nulls in both row and column directions.

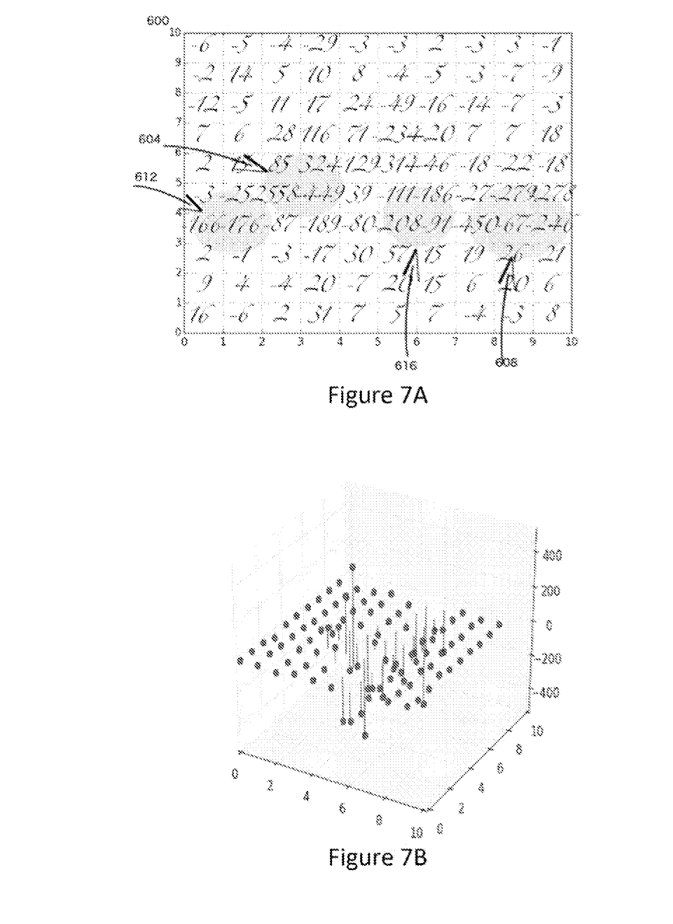

Rapid probe motion modulates capacitance during a measurement, which complicates the averaging process needed to estimate mutual capacitance. FIGS. 7A-B shows profiles of mutual capacitance as estimated by a Walsh-transform technique when a probe is moving horizontally at a significant fraction of one grid line (6 mm in this case) per frame (5 msec in this case). The probe position is indicated by the bi-lobe pattern at 604, but at 608, 612 and 616 images of the probe can be seen: these are caused by modulation of the Walsh drive function by the rapid probe motion, causing it to correlate with Walsh sequences different from those of the probed rows.

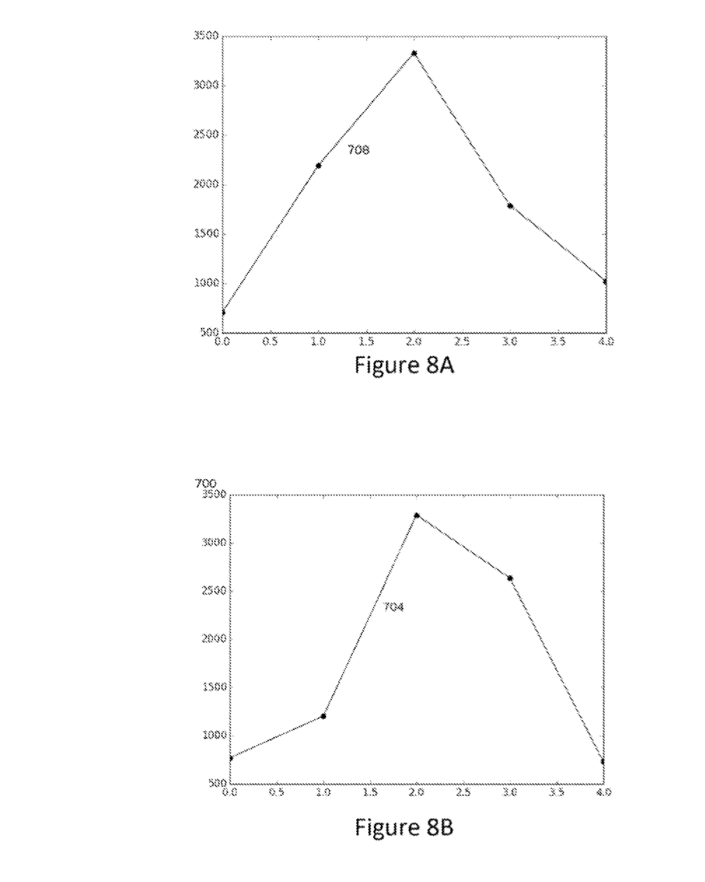

It is to be appreciated with the benefit of this description that an iterative technique for analyzing profiles such as those in FIG. 6 can be used to estimate profiles like those in FIG. 6 as separable, i.e. as outer products of one-dimensional vectors. FIGS. 8A-B shows generally at 700 such per-column and per-row profiles for single-ended drive and receive, with 704 showing the row profile and 708 the column profile. Forming the outer product of these gives a good approximation of the measured two-dimensional profile, and the zero crossings of each one-dimensional profile are good estimates of probe centroid position.

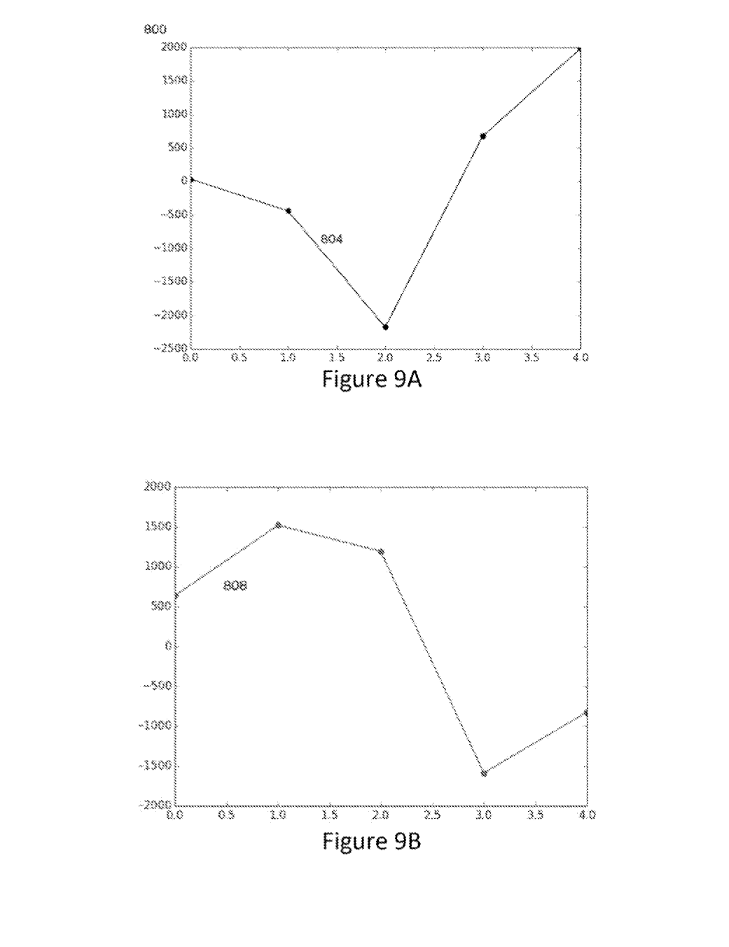

Similarly, FIGS. 9A-B shows generally at 800 per-column and per-row profiles for differential drive and receive, with 804 showing the row profile and 808 showing the column profile.

It is to be appreciated with the benefit of this description that a Kalman filtering approach can be used to track probes, which advantageously adapts automatically to varying signal-noise ratios. It further discloses a re-ordering of the conventional Kalman filter calculation to provide predicted probe locations at future frames. It further discloses sequential and iterative joint estimation of probe positions, in which the contributions of each estimated probe are removed from the overall measurement before estimating others.

There exist in-cell and related techniques where drive waveforms are not freely chosen.

These issues and techniques are not unique to capacitive touch panels, but shared by any sense technology having a grid of sense lines. There are also one-dimensional sensors having only a single layer of sense lines but with the same wiring problem, and optical and acoustic techniques to localize objects in three dimensions.

The grid geometry can also be generalized to use more complex patterns, such as zig-zags, and could be generalized to take advantage of more than two layers. Driving row and column lines from both ends can be used to reduce RC delays in the very thin sense lines, and to subdivide a panel into two or four subpanels, dividing row and column sense lines at the centre of the panel.

In some embodiments sense waveforms may be chosen to facilitate analysis with a Fourier transform and to permit power saving through the use of inductive nulling or its charge-sharing equivalents. The same technique may be applied more generally for sensors of other types, such as resistance or optical transmissivity, and to sensing in one or more dimensions.

A sinusoidal and four-phase driving and sensing techniques operable to simultaneously estimate position and velocity of a probe, such as a finger or stylus, in a touch panel is disclosed. The techniques can be applied to one-dimensional (e.g. line) sensors; or to single-probe separable sensing in a two-dimensional panel by independently applying the technique on rows and columns; or to multi-touch sensing where a mutual-capacitance technique is used for disambiguation. Extension to three dimensions for suitable interfaces can be envisaged. Compatible detection and avoidance of narrowband interference, such as from switching regulators, is disclosed.

A Fourier drive technique for mutual-capacitance sensing operable to simultaneously estimate position and velocity in two dimensions is also disclosed. The technique is suitable for stand-alone use in mutual-capacitance panel sensing or for disambiguation with the one-dimensional separable techniques and can allow simultaneous superimposed self- and mutual-capacitance estimation in both rows and columns. Multi-tone and sparse variants are disclosed.

Power-efficient drive techniques are disclosed. The power-efficient drive techniques are generally adaptive to where in a panel probes are expected to be found, for example by extrapolation from previous frames; and to the presence or absence of probes, for example by sensing at low resolution until a probe is detected.

The power-efficient drive techniques are well-suited to Fourier drive and the use of a frequency band known or found to be relatively free of external interference.

In a first embodiment for a one-dimensional sensor in which an initial estimate of probe position is available, four adjacent sense lines centered on the expected probe position are driven with sinusoidal voltages of a common frequency but having phases progressively spaced by ninety degrees, as for example with signals v₀=Vₛₑₙₛₑ cos ω₀t, v₁=Vₛₑₙₛₑ sin ω₀t, v₂=−Vₛₑₙₛₑ cos ω₀t, v₃=−Vₛₑₙₛₑ sin ω₀t, and the resultant total current measured. If mutual capacitances are negligible and self-capacitances are C₀, C₁, C₂, C₃ respectively then total drive current will be i_{d}=ω₀Vₛₑₙₛₑ((C₂−C₀) sin ω₀t+(C₁−C₃ cos ω₀t)), which can be thought of as a phasor with real part and imaginary part Vₛₑₙₛₑω₀(C₁−C₃) and imaginary part Vₛₑₙₛₑω₀(C₂−C₀). When the probe is centered between rows 1 and 2 then there will be a positive Δ_{c}=C₂−C₀=C₁−C₃ and the phasor will have the form e^{jπ/4} Vₛₑₙₛₑω₀, where the phase term e^{φ}=e^{jπ/4} represents position and the Δ_{c} term represents the size of the probe. Placing the probe over sense line 1 increases C₁ while leaving C₂−C₀=0 and the phasor becomes pure real (φ=0), while placing it over sense line 2 makes the phasor pure imaginary (φ=π/2). Thus position corresponds directly to phase angle.

Probe capacitance Δ_{c} and phasor angle φ can be estimated by correlating measured drive current i_{d} with cos ( ) and sin ( ) terms, or equivalently by correlating with e^{-jω}^{₀}^{t}. Correlation allows averaging of noisy estimates i_{d} to produce accurate position and capacitance estimates.

Since position maps to phase, velocity maps to frequency, measuring the frequency of the signal i_{d} can be used to provide a velocity of the probe. In the present embodiment, the signal is correlated with complex exponentials e^{j(ω}^{₀}^{±ω}^{₁}^{)t} is used, where ω₁=2*π/T and T is the frame time (e.g. 4 msec for a 250 Hz frame rate). Accordingly, three complex measurements at three frequencies (ω₀−ω₁, ω₀, ω₀+ω₁) of a noisy i_{d}=αexp (jω_{probe}t)+iₙₒᵢₛₑ(t) are provided and can be used to solve for α and ω_{probe}.

The above embodiment neglected interline capacitances, and this may be a problem because they are in practice large. The inner pair of lines receive compensating error currents from their neighbours, but the outer two do not. One solution is to precompensate drive voltages, but in a further embodiment driving sense lines on either side of the main group of four lines, so that six lines are driven with signals v₋₁=−sin (ω₀t), v₀=cos ω₀t, v₁=sin ω₀t, v₂=−cos ω₀t, v₃=−sin ω₀t, and v₄=cos (ω₀t) is used. This compensates the four innermost lines and provides additional signal from the new outermost lines that can be useful when the initial estimate of probe position is poor.

For sense lines near the edge of a screen, signal-noise ratio is generally worse than for lines in the body of the screen, partly because fewer field lines intersect the probe. Sensitivity can be enhanced in these areas by increasing Vₛₑₙₛₑ or by increasing integration times. In practice a Kalman filter automatically increases integration times in area of poor signal-noise ratio, as long as accurate estimates are available to it of sample noise.

The above embodiments required an initial estimate of probe position. In operation, there are two phases: acquisition and tracking. The usual case is tracking, in which for example the modified Kalman filter provides this estimate. The rarer acquisition case is that a new probe approaches the screen.

In an embodiment of acquisition, all sense lines are driven with a signal V_{acq} cos (ω_{acq}t), their currents individually measured and spatial averaging used to identify hotspots that may reflect approaching probes. It is not necessary to detect hotspot position as accurately as probe position, and false positives are allowable, because the results of acquisition are not reported as probe positions but only used to guide measurement. It is therefore allowable to use smaller power levels for acquisition than for tracking, which is desirable because acquisition is active over the entire screen. Acquisition may be done in a burst fashion if drive at low levels is inefficient. Acquisition can be done simultaneously with measurement and tracking by choosing ω_{acq} to differ from ω₀ by some N2π/T for an integer N, preferably N>2, so that acquisition and tracking measurements are at orthogonal frequencies.

The sense lines can be driven with currents and sum voltages, rather than the dual approach of the first embodiment. It may be preferable to sense differentially, in order to cancel interference. This may be done in a fashion compatible with the four-phase drive and phasor/frequency estimation by sensing (V₀−V₁)+(V₂−V₃): the two sin ( ) terms are inverted, but this just changes the direction of rotation of the phasor.

Phase-shift or differencing circuits can be used on the receiver rather than on the driver to obtain the desired phases, or to combine phase-shifting on the driver and receiver to get the desired effect. Angles other than 90 degrees can be used, and can be preferable depending on the ratio of probe diameter to sense-line pitch.

The correlations can be simplified, for example by correlating just with ω₀ and ω₀+π/2T. It is to be appreciated with the benefit of this description that various techniques can be applied such as using a modified Kalman filter's prediction of velocity and therefore of an estimate [symbol] of ω_{probe} to allow correlation at frequencies [symbol] and [symbol] π/2T.

Several probes can be tracked simultaneously.

In the two-dimensional case, different areas can be sensed simultaneously at orthogonal sense frequencies (i.e. differing by N2π/T) in order to allow mutual capacitance measurements to be made.

In a first embodiment for two-dimensional panels with single touches, a one-dimensional technique, for example as disclosed above, is used both on rows and on columns. Preferably, sense frequencies on row and column lines are orthogonal and well separated so that velocity modulation on one axis does not couple to cause material errors in measuring on the other axis.

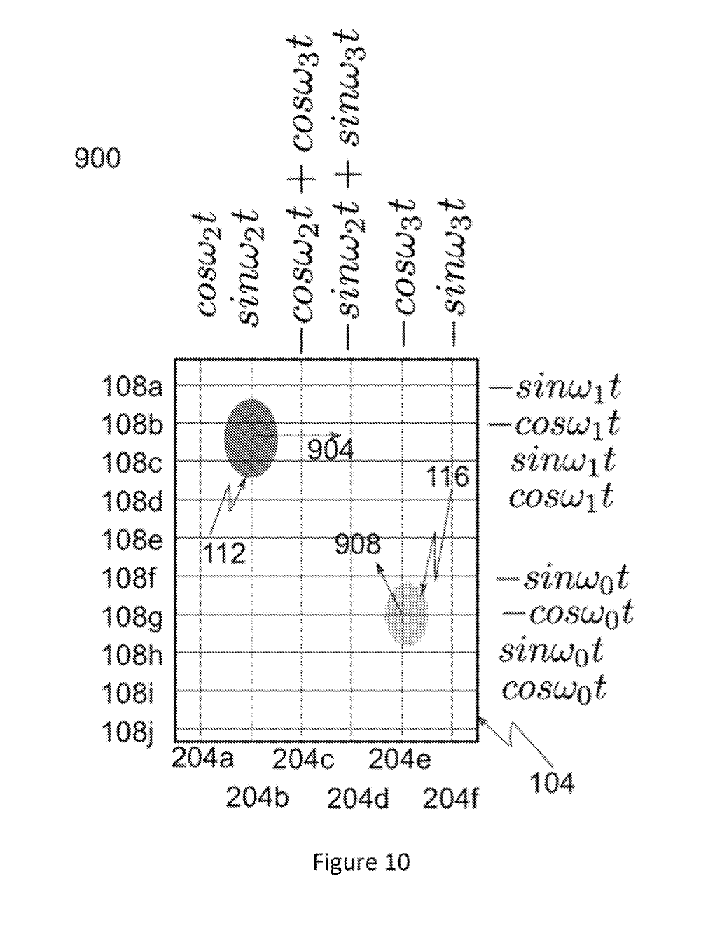

In a first embodiment of hybrid sensing for multi-touch two-dimensional panels, well-separated orthogonal frequencies are used for sensing each group of lines. Mutual capacitance terms are therefore distinguishable from self-capacitance terms and from each other. FIG. 10 shows generally at 900 the touch panel of FIG. 3 wherein the two probes 112 and 116 are moving in directions and at speeds as indicated by vectors 904 and 908 respectively. Also indicated are drive signals for columns and rows near the probe locations, illustrating use of four phases at each of four different test frequencies ω₀, ω₁, ω₂, ω₃, and illustrating superposition of signals at ω₂ and ω₃. When multiple frequencies are to be sensed it may be advantageous to use a fast Fourier transform technique for analysis.

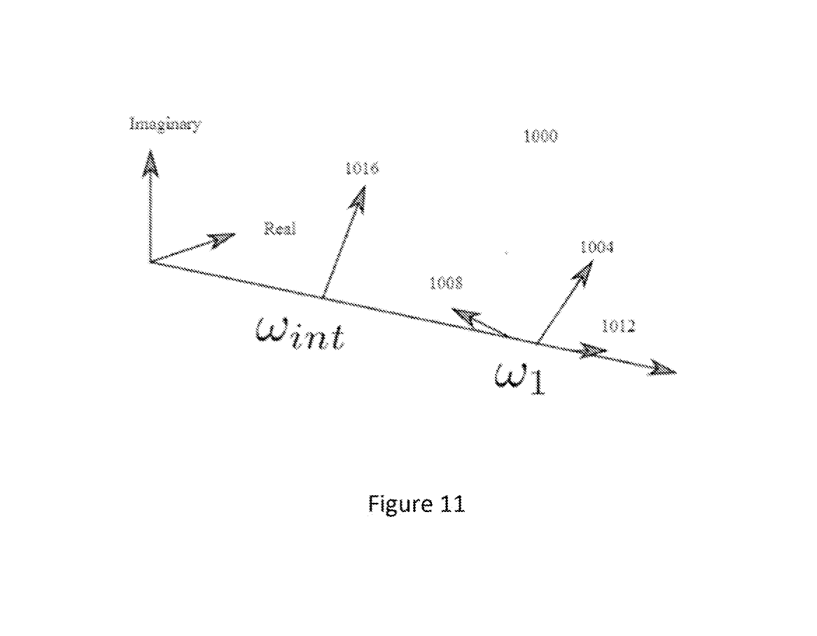

FIG. 11 shows generally at 1000 an exemplary Fourier transform of one-dimensional sensing at a frequency ω₁ of a moving probe in the presence of narrowband interference from a switching power supply operating at frequency ωᵢₙₜ. The phase of Fourier component 1004 is indicative of position, and the magnitudes of Fourier components 1008 and 1012 relative to Fourier component 1004 are indicative of velocity. Fourier component 1016, located at a frequency distinct from any drive signal frequency or plausible modulation thereof, is indicative of interference. Drive frequencies may be chosen in white space areas measured to have little interference. In-band noise may be estimated by deviation of ratios of Fourier components 1008 and 1012 to 1004 from those that are physically plausible.

In all of the above embodiments it may be preferable to inductively load sense lines so as to reduce required drive currents and to filter interfering signals.

While specific embodiments have been described and illustrated, such embodiments should be considered illustrative only and should not serve to limit the accompanying claims.

What is claimed is:

1. A sensing system for measuring a position and a velocity of a probe, the sensing system comprising:
a panel;
a plurality of sense lines disposed in the panel, the plurality of sense lines configured to measure data associated with the probe;
a driver circuit connected to the plurality of sense lines, the driver circuit configured transmit a plurality of drive signals at an initial frequency to the plurality of sense lines;
a receiver circuit connected to the plurality of sense lines, the receiver circuit configured to receive a plurality of sensed signals, each sensed signal of the plurality of sensed signals being received from a sense line of the plurality of sense lines, wherein each sensed signal comprises a sensed phased and a sensed frequency; and
a plurality of differencing circuits configured to phase-shift a signal associated with each sense line of the plurality of sense lines;
a signal processing circuit connected to receive a plurality of processing signals associated with the plurality of sensed signals, the signal processing circuit configured to determine correlation components of each processing signal with an associated drive signal to calculate a position and a velocity of the probe.

2. The sensing system of claim 1, wherein each drive signal of the plurality of drive signals is a sinusoid, and wherein the correlation components comprise a measured phase and a measured frequency.

3. The sensing system of claim 2, wherein the signal processing circuit is configured to correlate the plurality of processing signals with complex exponentials at different frequencies.

4. The sensing system of claim 1, wherein the plurality of differencing circuits are configured to phase-shift each drive signal of the plurality of drive signals by a different amount.

5. The sensing system of claim 4, wherein the plurality of differencing circuits are configured to phase-shift a first drive signal about 90 degrees relative to a second drive signal, wherein the first drive signal and the second drive signal are associated with adjacent sense lines.

6. The sensing system of claim 1, wherein the plurality of differencing circuits are configured to phase-shift each sensed signal of the plurality of sensed signals by a different amount.

7. The sensing system of claim 6, wherein the plurality of differencing circuits are configured to phase-shift a first sensed signal about 90 degrees relative to a second sensed signal to generate a first processing signal and a second processing signal, respectively, wherein the first sensed signal and the second sensed signal are associated with adjacent sense lines.

8. The sensing system of claim 1, wherein the plurality of sense lines comprises a conductive material.

9. The sensing system of claim 8, wherein the receiver circuit is configured to detect a capacitance from the plurality of sense lines.

10. The sensing system of claim 1, wherein each drive signal comprises a Walsh waveform.

11. A method of measuring a position and a velocity of a probe, the method comprising: transmitting, using a driver circuit, a plurality of drive signals to a plurality of sense lines;
receiving, using a receiver circuit, a plurality of sensed signals, each sensed signal of the plurality of sensed signals being received from a sense line of the plurality of sense lines, wherein each sensed signal comprises a sensed phased and a sensed frequency;
phase-shifting, using a plurality of differencing circuits, a signal associated with each sense line of the plurality of sense lines;
determining, using a signal processing circuit, correlation components of each processing signal of a plurality of processing signals associated with the plurality of sensed signals; and
calculating a position and a velocity of the probe using the correlation components of each processing signal of a plurality of processing signals.

12. The method of claim 11, wherein transmitting comprises transmitting a plurality of sinusoidal drive signals, and wherein the correlation components comprise a measured phase and a measured frequency.

13. The method of claim 12, further comprising correlating, using the signal processing circuit, the plurality of processing signals with complex exponentials at different frequencies.

14. The method of claim 11, wherein phase-shifting a signal comprises phase-shifting each drive signal of the plurality of drive signals by a different amount.

15. The method of claim 14, wherein phase-shifting comprises phase-shifting a first drive signal about 90 degrees relative to a second drive signal, wherein the first drive signal and the second drive signal are associated with adjacent sense lines.

16. The method of claim 11, wherein phase-shifting a signal comprises phase-shifting each sensed signal of the plurality of sensed signals by a different amount.

17. The method of claim 16, wherein phase-shifting comprises phase-shifting a first sensed signal about 90 degrees relative to a second sensed signal, wherein the first sensed signal and the second sensed signal are associated with adjacent sense lines.

18. The method of claim 11, wherein the plurality of sense lines comprises a conductive material.

19. The method of claim 18, wherein receiving a plurality of sensed signals comprises receiving capacitance data from the plurality of sense lines.

20. The method of claim 11, wherein transmitting comprises transmitting a plurality of Walsh waveforms.
